(19) United States
(12) Patent Application Publication
(10) Pub. No.: US 2009/0262328 A1
(43) Pub. Date: Oct. 22, 2009

(54) ILLUMINATION SYSTEM AND LITHOGRAPHIC METHOD

(75) Inventors: Jan Bernard Plechelmus VAN SCHOOT, Eindhoven (NL); Erik Roelof Loopstra, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/426,804

(22) Filed: Apr. 20, 2009

Related U.S. Application Data
(60) Provisional application No. 61/071,312, filed on Apr. 22, 2008.

(51) Int. Cl. G03B 27/32; G02B 26/10; G03B 27/42

(52) U.S. Cl. 355/77; 359/201.1; 355/53

(57) ABSTRACT

An illumination system of a lithographic apparatus is disclosed that includes a first optical element to receive a radiation beam, the first optical element comprising first raster elements that partition the radiation beam into a plurality of radiation channels, and a second optical element to receive the plurality of radiation channels, the second optical element comprising second raster elements. For each of the radiation channels a raster element of said first raster elements is associated with a respective raster element of said second raster elements to provide a continuous beam path from said first optical element to an object plane. A filter is disposed in a path traversed by the radiation beam to create a desired spatial intensity distribution in a pupil of the illumination system, by, for example, reducing a transmittance of a selection of one or more of the radiation channels.

This application claims priority and benefit under 35 U.S.C. §119(e) to U.S. Provisional Patent Application No. 61/071,312, entitled “Illumination System and Lithographic Method”, filed on Apr. 22, 2008. The content of that application is incorporated herein in its entirety by reference.

### FIELD

The invention concerns an illumination system, such as for wavelengths smaller than or equal to 193 nm, for example, extreme ultraviolet (EUV) radiation, a method for adjusting the illumination in an exit pupil of an illumination system, as well as a lithographic projection exposure apparatus comprising such an illumination system.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to impart a beam of radiation with a pattern in its cross-section, the pattern corresponding to a circuit pattern to be formed on an individual layer of the IC. This pattern can be imaged or transferred onto a target portion (e.g. comprising part of, one, or several dies) on a substrate (e.g. a silicon wafer). Transfer of the pattern is typically via imaging, using a projection system, onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an image of the entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction.

In order to allow a further reduction in the line widths of, for example, electronic components, it is desirable to reduce the wavelength of the radiation used for the imaging and exposing. For example, with wavelengths less than 193 nm, lithography with soft X-rays, so-called EUV lithography is possible.

The lithographic apparatus generally includes an illumination system. The illumination system receives radiation from a source, such as a laser produced plasma EUV source, and produces an illumination beam to illuminate the patterning device. Within a typical illumination system, the beam is shaped and controlled such that at a pupil plane of the illumination system the beam has a desired spatial intensity distribution. Such a spatial intensity distribution at the pupil plane effectively acts as a virtual radiation source for producing the illumination beam. Various shapes of said intensity distribution, consisting of (substantially uniform) light areas on a dark background, can be used. Any such shape will be referred to hereinafter as an “illumination mode”. Known illumination modes include: conventional illumination (a top-hat disc-shaped intensity distribution in said pupil), annular illumination, dipole illumination, quadrupole illumination and more complex shaped arrangements of the illumination pupil intensity distribution. A radial extent in said pupil plane corresponds to an angle of incidence at the patterning device, and its value normalized by a maximum radial extent corresponding to the numerical aperture (NA) of the projection system is commonly referred to by σ.

A basic construction principle of a double-faceted EUV illumination system is disclosed in German patent application publication no. DE 19903807 A1. The illumination system comprises a first optical element to receive the radiation beam, where the first optical element has first raster elements that partition said radiation beam into a plurality of radiation beams, referred to hereinafter as radiation channels. These first raster elements are, hereinafter, also called field raster elements. The system further comprises a second optical element to receive said radiation channels, where the second optical element has second raster elements. An object plane, coincident with a plane of a patterning device, receives said radiation channels via said second optical element, and subsequently the radiation channels irradiate an exit pupil of the illumination system via said object plane. For each of the radiation channels a raster element of said first raster elements is associated with a raster element of said second raster elements, in accordance with a fixed assignment, to provide a continuous beam path from said first optical element to said object plane. The plurality of radiation channels is arranged to provide uniform illumination of the patterning device in the object plane. The illumination in the pupil of the illumination system is determined, according to DE 19903807, by the arrangement of the raster elements on the second mirror.

A variable controlling of the illumination mode in the pupil or the adjustment of an intensity distribution in the pupil, of such an illumination system is disclosed in U.S. Pat. No. 6,658,084. The illumination system is suitable for EUV lithography; it provides homogeneous, i.e., uniform, illumination of the field used in EUV lithography, particularly the ring field of an objective, with as few reflections as possible. Furthermore, it provides illumination up to a particular filling ratio a, independently of a position in the field. In the illumination system a predetermined illumination in the pupil is adjusted by altering points of incidence of radiation channels traveling from a light source to the pupil. By means of such an adjustment of the light distribution in the pupil, any given distributions can be realized and losses of light, such as occur for example in the solutions using diaphragms, can be avoided. The system is characterized by said assignment of a raster element of said first raster elements and a raster element of said second raster elements to said radiation channels being changeable to provide an adjustment of the intensity distribution in the pupil of the illumination system.

The different illumination settings can be realized in the double-faceted illumination system by exchanging the first optical element with its field raster elements for another, different first optical element with corresponding differently tilted field raster elements. Then, only the pupil raster elements of a particular setting, such as the quadrupole setting, can be illuminated on the second optical element. To achieve this the pupil raster elements are adapted to the illumination of the field raster elements. However, optical elements with raster elements are costly elements. Particularly, implementing an arrangement including an exchanger arranged for using a plurality of exchangeable first optical elements is complicated and costly.

### SUMMARY

An object of an embodiment of the invention is to provide a less costly construction of a double-faceted illumination system, which allows a variable adjustment of an illumination mode, as well as a method for adjusting an illumination mode in such an illumination system.

According to an embodiment of the invention, there is provided an illumination system comprising a first optical element to receive a radiation beam, the first optical element comprising first raster elements that partition said radiation beam into a plurality of radiation channels, a second optical element to receive said plurality of radiation channels, the second optical element comprising second raster elements, and an object plane arranged to receive said radiation channels via said second optical element and a pupil, wherein for each of the radiation channels a raster element of said first raster elements is associated with a respective raster element of said second raster elements to provide a continuous beam path from said first optical element to said object plane, the association being such that a spatial distribution of the first raster elements is incongruent to a spatial distribution of the respective associated second raster elements, and further comprising a spatial filter disposed in a path traversed by the radiation beam to create different illumination modes.

According to an aspect of the invention the spatial filter is disposed between a source, and the first optical element, the source being arranged to provide the radiation beam to the illumination system. In particular, a position along a path traversed by the radiation beam of the spatial filter may be arranged such that the spatial filter is traversed both by radiation impinging on the first optical element, and by radiation reflected off the first optical element. The spatial filter may have a plurality of transmissive areas arranged in a body that is at least partially blocking of radiation of the radiation beam, and a plurality of the transmissive areas may be disposed in juxtaposed registry with a corresponding, selected plurality of first raster elements. The selected plurality of first raster elements selection may be arranged to provide a desired spatial intensity distribution in the pupil plane, such as, for example, a spatial intensity distribution corresponding to an illumination mode comprising dipole illumination, or quadrupole illumination, or annular illumination.

According to an aspect of the invention there is provided a lithographic apparatus including an illumination system as described above.

According to a further aspect of the invention there is provided a lithographic method comprising imparting a beam of radiation exiting from an illumination system with a pattern in its cross-section using a patterning device, projecting the pattern onto a substrate, the illumination system including a first optical element comprising first raster elements that partition said radiation beam into a plurality of radiation channels; a second optical element arranged for receiving said plurality of radiation channels, and comprising second raster elements; an object plane arranged to receive said radiation channels via said second optical element and a pupil, wherein each raster element of said first raster elements is associated with a respective raster element of said second raster elements, and a spatial distribution of the first raster elements is incongruent to a spatial distribution of the of the respective associated second raster elements, the method further including spatially filtering the radiation beam to create a preselected intensity distribution in the pupil.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a radiation beam path of a system including a source and a reflective illumination system with two optical elements, each having raster elements;

FIG. 2A depicts a top view of a first optical element including first raster elements, the first raster elements being consecutively numbered for identification;

FIG. 2B depicts a top view of a second optical element including second raster elements, the second raster elements being numbered to express an association of each second raster element to a respective and correspondingly numbered first raster element;

FIG. 3 illustrates a position of a spatial filter in the beam path, and in accordance with an embodiment of the invention;

FIG. 4A shows a top view of a spatial filter having a plurality of clear apertures and illustrates a positioning of these apertures in juxtaposed registry with corresponding first raster elements;

FIG. 4B shows a top view of irradiated second raster elements contributing to small a conventional illumination obtained in the presence of the filter as illustrated in FIG. 4A;

FIG. 5A shows a top view of a further spatial filter having a plurality of clear apertures and illustrates a positioning of these apertures in juxtaposed registry with corresponding first raster elements;

FIG. 5B shows a top view of irradiated second raster elements contributing to medium size σ annular illumination obtained in the presence of the filter as illustrated in FIG. 5A; and

FIG. 6 depicts a lithographic apparatus according to an embodiment of the invention.

### DETAILED DESCRIPTION

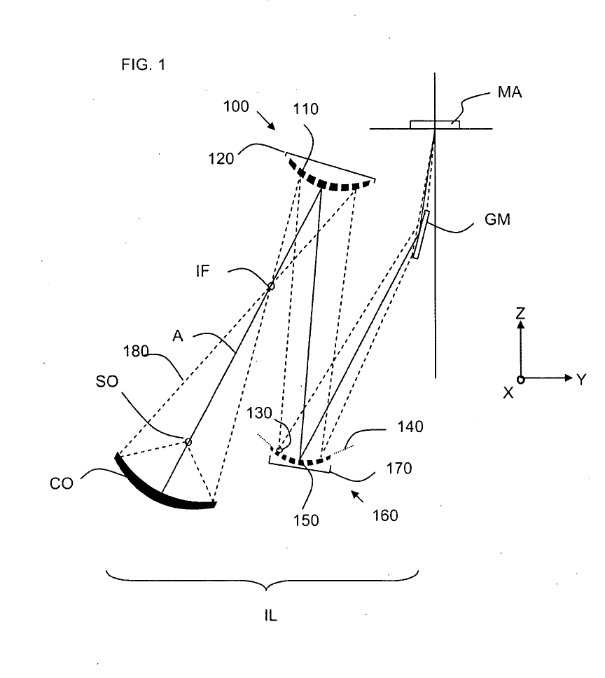

FIG. 1 shows a schematic diagram of the beam path of an illumination system IL with first and second faceted optical elements 100 and 160 in reflective representation. The beam path is schematically indicated by an axis A. The radiation of a light source SO is collected by means of a collector mirror CO and converted into a convergent light bundle centered around the axis A. An image of the source SO is located at an intermediate focus IF. The first optical element 100 includes first raster elements 110 (also referred to hereinafter as field raster elements 110) that are arranged on a first raster element plate 120. The field raster elements 110 divide the radiation beam impinging on the first optical element 100 into a plurality of radiation channels and create secondary light sources 130 at a surface 140, where second raster elements 150 (also referred to hereinafter as pupil raster elements 150) of the second optical element 160 are disposed. The pupil raster elements 150 are arranged on a second raster element plate 170. The secondary light sources 130 are disposed in a pupil of the illumination system. Optical elements not shown in FIG. 1, downstream of the second optical element 160, may serve to image the pupil onto an exit pupil of the illumination system (not shown in FIG. 1). An entrance pupil of a projection system coincides with the exit pupil of the illumination system (in accordance with so-called “Köhler illumination”). The reflective illumination system IL may further comprise optical elements such as a grazing-incidence field mirror GM, constructed and arranged for field-imaging and field-shaping.

The raster elements 110 and 150 of the first and second optical elements 100 and 160 are constructed as mirrors. The raster elements 110 and 150 are arranged on raster element plates 120 and 170, respectively, with a particular orientation, e.g., position and angle of tilt.

With a selected orientation, e.g., angle of tilt, of individual field raster elements 110 on first raster element plate 120, it is possible to fix the one-to-one assignment of each field raster element 110 to a corresponding pupil raster element 150 on the second raster element plate 170.

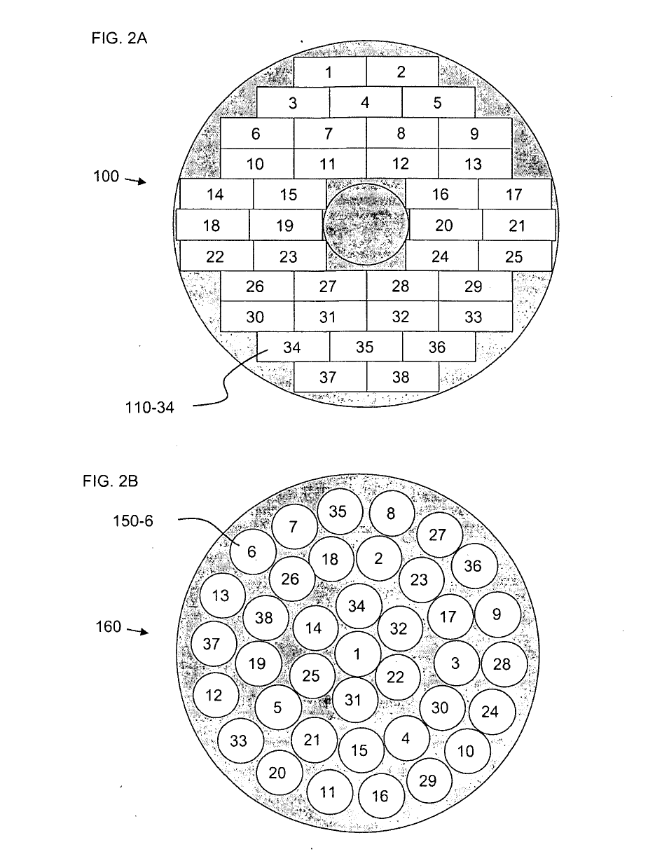

For reducing non-uniformity of the illumination at the object plane coincident with the patterning device MA the assignment of field raster elements 110 to pupil raster elements 150 may differ from an assignment as shown in FIG. 1 by the dotted lines 180. An example of such a different assignment is illustrated in FIG. 2. In FIG. 2A the field raster elements 120-1 up to 120-38 are disposed in adjacent rows, and can be numbered from left to right, and from top row to bottom row. In FIG. 2B the pupil raster elements 150-1 tip to 150-38 are illustrated; a pupil raster element 150 assigned to a field raster element 110 carries the same raster element number-extension. Clearly, the spatial distribution in the x,y plane of the pupil raster elements 150-1 up to 150-38 differs from the spatial distribution of the corresponding field raster elements 110-1 up to 110-38 in the sense that the two distributions are incongruent. Such a spatially incongruent assignment may be employed to alleviate an effect of source inhomogeneity.

In conventional use of the illumination system, all the secondary light sources 130 contribute to the illumination of the patterning device MA, and the arrangement of pupil raster elements is such that a conventional illumination mode is provided (wherein a uniform intensity in a disk shaped area in the pupil of the illumination system is approximated by a uniform distribution of secondary light sources 130 over the pupil).

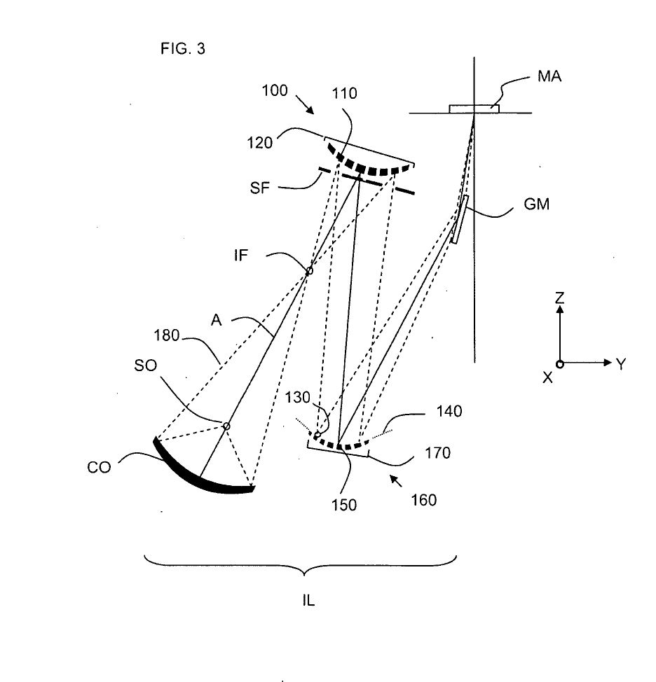

According to an embodiment of the present invention, and as illustrated in FIG. 3, a spatial filter SF may be disposed in the optical path to create different illumination modes, such as quadrupole and annular illumination modes. The spatial filter SF may be disposed in the optical path between the intermediate focus IF and the first optical element 100, the position along the axis A such that the filter SF is traversed both by light impinging on the first optical element 100, and by light reflected off the first optical element 100. The spatial filter SF has a plurality of transmissive areas 410 arranged in a at least partially light blocking body 420. For example, the filter SF may be embodied as a metal blade with a plurality of apertures.

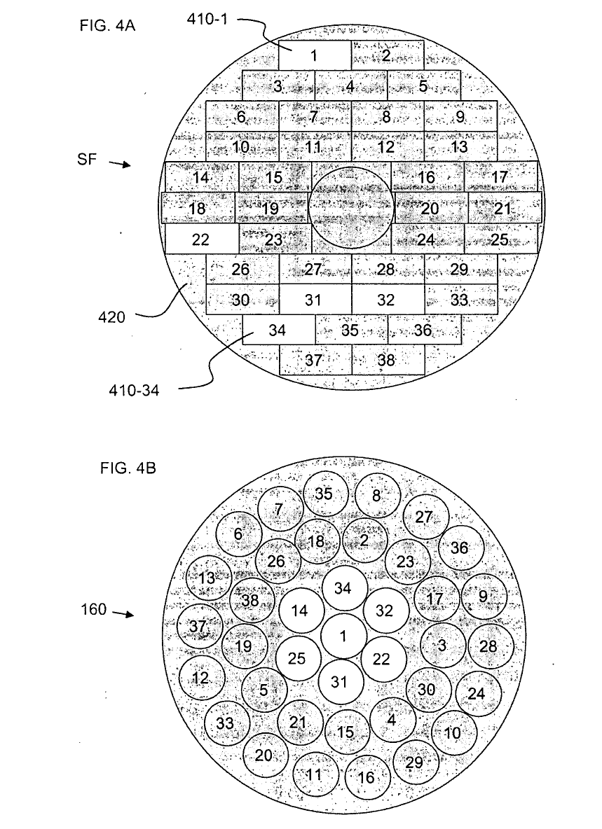

FIG. 4A illustrates an embodiment of the spatial filter SF suitable for creating a small σ illumination mode. FIG. 4B shows that a small σ conventional illumination mode can be created by having only the pupil raster elements 150-1, 150-14, 150-22, 150-25, 150-31, 150-32 and 150-34 be traversed by corresponding radiation channels, and by having the remainder of the pupil raster elements not being traversed by a radiation channel. Transmissive areas 420 are arranged in spatial correspondence with corresponding field raster elements 110-1, 110-14, 110-22, 110-25, 110-31, 110-32 and 110-34. The spatial filter SF is disposed in juxtaposed registry with the field raster elements 110 such that openings 410-1, 410-14, 410-22, 410-25, 410-3 1, 410-32 and 410-34 are enabling radiation channels to traverse the corresponding field raster elements 110-1, 110-14, 110-22, 110-25, 110-31, 110-32 and 110-34.

The at least partially radiation blocking body 420 of the spatial filter SF absorbs or reflects impinging radiation. thereby reducing a radiation induced heating of the first optical element 100. Radiation channels traversing the filter SF are, however, heating up the first optical element 100 due to residual absorption of radiation by the irradiated field raster elements 110-1, 110-14, 110-22, 110-25, 110-31, 110-32 and 110-34, i.e., the active field raster elements 110. An aspect of the invention is that such a heating is distributed more evenly over the first optical element 100 than it would have been in the case of congruent assignment of field raster elements 110 to pupil raster elements 150. It is appreciated that such a more even spread of heat over the first optical element 100 can be arranged more effectively than suggested by FIG. 4 because in practice there may be, for example, several hundreds of field raster elements in total.

A conventional pupil aperture blade may be placed near the pupil to create a small a illumination mode. In principle, by using such a blade the same pupil field raster elements 150-1, 150-14, 150-22, 150-25, 150-31, 150-32 and 150-34 may be irradiated exclusively. However, according to a further aspect of the invention, radiation is desirably blocked at a position along the axis A as close as possible to the source, such as to decrease the number of optical elements that are fully exposed to radiation emitted by the radiation source. Any such decrease helps mitigate a problem due to heating of optical elements such as first optical element 100. For example, an optical element fully exposed to the radiation may thermally deform and induce optical aberrations beyond tolerance.

It is further appreciated that costs to implement and use a blade as shown in FIG. 4A can be much less costly than using an exchangeable additional optical element comprising a plurality of raster elements such as the first optical element 100.

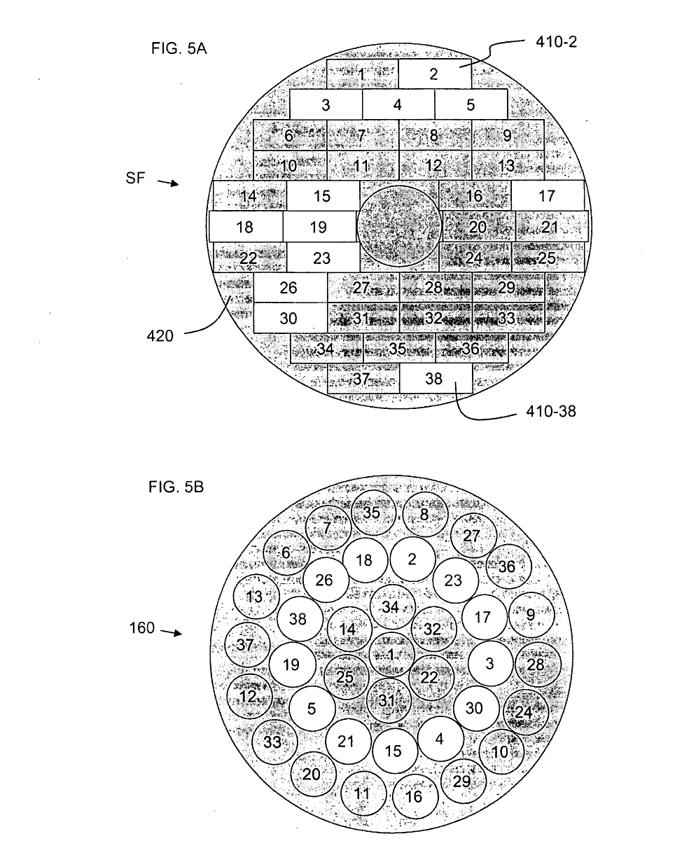

A further embodiment described with respect to FIG. 5 is the same as the embodiment described with respect to FIG. 4, except that the filter is arranged to create an annular illumination mode. As shown in FIG. 5., a spatial filter SF, disposed in juxtaposed registry with the field raster elements 110, embodied with apertures 410-2, 410-3, 410-4, 410-5, 410-15, 410-17, 410-18, 410-19, 410-21, 410-23, 410-26, 410-30, and 410-38, enables radiation channels to create secondary light sources arranged in an annular area in the pupil. Similarly, the filter SF may be arranged to create a quadrupole illumination mode or a dipole illumination mode or any other, more complicated illumination mode.

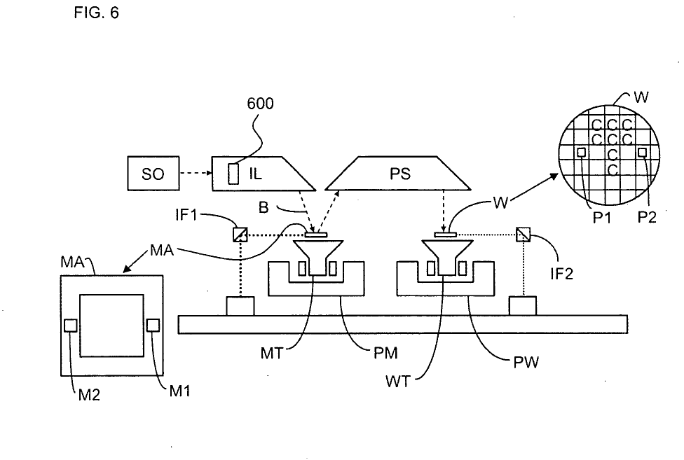

In any of the embodiments, the spatial filter SF can be part of a set of spatial filters which all are part of a filter exchange device 600, as shown in FIG. 6. FIG. 6 schematically shows an EUV lithographic apparatus according to an embodiment of the present invention. The apparatus comprises:
the illumination system (illuminator) IL configured to condition a radiation beam B (e.g. EUV radiation), and as illustrated in more detail in FIG. 3;
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system PS configured to project a pattern imparted to the radiation beam B by patterning device MA onto a target portion C (e.g. comprising one or more dies) of the substrate W.

The support structure MT holds the patterning device. It holds the patterning device in a manner that depends on the orientation of the patterning device, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as required. The support structure MT may ensure that the patterning device is at a desired position, for example with respect to the projection system.

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The term “projection system” used herein should be broadly interpreted as encompassing any type of projection system, including reflective or catadioptric optical systems or any combination thereof, as appropriate for the exposure radiation being used.

As here depicted, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 6, the illuminator IL receives a radiation beam from a radiation source SO. The entity including the source SO and the condensor CO (see FIG. 1) may be an entity separate from the lithographic apparatus. In such cases, the source is not considered to form part of the lithographic apparatus and the radiation beam may be passed from the source SO to the illuminator IL with the aid of a beam delivery system comprising, for example, suitable directing mirrors and/or a beam expander. The source SO and the illuminator IL, together with the beam delivery system if required, may be referred to as a radiation system.

The illuminator IL may comprise a spatial filter exchanger or holder device 600 to adjust the illumination mode.

The radiation beam B is incident on the patterning device (e.g., mask MA), which is held on the support structure MT (e.g., mask table), and is patterned by the patterning device. Having traversed the patterning device MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the patterning device table MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In an embodiment, there is provided an illumination system comprising: a first optical element to receive a radiation beam, the first optical element comprising first raster elements that partition the radiation beam into a plurality of radiation channels; a second optical element to receive the plurality of radiation channels, the second optical element comprising second raster elements; and a spatial filter disposed or arranged to be disposed in a path traversed by the radiation beam to create an illumination mode, wherein, for each of the radiation channels, a raster element of the first raster elements is associated with a respective raster element of the second raster elements to provide a continuous beam path from the first optical clement to an object plane arranged to receive the radiation channels via the second optical element and a pupil, the association being such that a spatial distribution of the first raster elements is not congruent to a spatial distribution of the respective associated second raster elements.

The spatial filter may be disposed or arranged to be disposed between a source, the source being arranged to provide the radiation beam to the illumination system, and the first optical element. In use of the illumination system, the spatial filter may be arranged such that the spatial filter is traversed both by radiation impinging on the first optical element, and by radiation reflected off the first optical element. The spatial filter may have a plurality of transmissive areas arranged in a body that at least partially blocks radiation of the radiation beam. A plurality of the transmissive areas of the spatial filter may be arranged to be in juxtaposed registry with a corresponding, selected plurality of first raster elements. The selected plurality of the first raster elements may be arranged to provide a desired spatial intensity distribution in the pupil. The desired spatial intensity distribution may correspond to an illumination mode comprising dipole illumination, or quadrupole illumination, or annular illumination. The spatial filter may be part of a set of spatial filters which all are part of a filter exchange device.

In an embodiment, there is provided a lithographic method comprising: conditioning a beam of radiation using an illumination system including a first optical element comprising first raster elements that partition the radiation beam into a plurality of radiation channels and a second optical element that receives the plurality of radiation channels, the second optical element comprising second raster elements, wherein each raster element of the first raster elements is associated with a respective raster element of the second raster elements, a spatial distribution of the first raster elements is not congruent to a spatial distribution of the respective associated second raster elements; spatially filtering the beam of radiation to create a selected spatial intensity distribution in an exit pupil of the illumination system; imparting the beam of radiation exiting from the illumination system with a pattern in its cross-section using a patterning device; and projecting the pattern onto a substrate.

The filtering may occur between a source, the source being arranged to provide the radiation beam to the illumination system, and the first optical element. The filtering may comprise traversal of a spatial filter both by radiation impinging on the first optical element, and by radiation reflected off the first optical element. The filtering may comprise using a spatial filter having a plurality of transmissive areas arranged in a body that at least partially blocks radiation of the radiation beam, and a plurality of the transmissive areas of the spatial filter are in juxtaposed registry with a corresponding, selected plurality of first raster elements. The selected plurality of the first raster elements may provide a desired spatial intensity distribution in the exit pupil. The desired spatial intensity distribution may correspond to an illumination mode comprising dipole illumination, or quadrupole illumination, or annular illumination. The filtering may comprise using a spatial filter to create the selected spatial intensity distribution and further comprising exchanging the spatial filter for another filter to create another selected spatial intensity distribution.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the tern substrate used herein may also refer to a substrate that already contains multiple processed layers.

The terms “radiation” and “beam” used herein encompass electromagnetic radiation of 248 nm, 193 nm, 157 nm or 126 nm wavelength and extreme ultra-violet (EUV) radiation (e.g. having a wavelength in the range of 5-20 nm).

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. An illumination system comprising:
a first optical element to receive a radiation beam, the first optical element comprising first raster elements that partition said radiation beam into a plurality of radiation channels;
a second optical element to receive said plurality of radiation channels, the second optical element comprising second raster elements;
an object plane arranged to receive the radiation channels via the second optical element and a pupil,
wherein, for each of the radiation channels, a raster element of the first raster elements is associated with a respective raster element of the second raster elements to provide a continuous beam path from said first optical element to the object plane, the association being such that a spatial distribution of the first raster elements is incongruent to a spatial distribution of the respective associated second raster elements, and
wherein a spatial filter is disposed in a path traversed by the radiation beam to create an illumination mode.

2. The illumination system of claim 1, wherein the spatial filter is disposed between a source, the source being arranged to provide the radiation beam to the illumination system, and the first optical element.

3. The illumination system of claim 1, wherein, in use of the illumination system, the spatial filter is arranged such that the spatial filter is traversed both by radiation impinging on the first optical element, and by radiation reflected off the first optical element.

4. The illumination system of claim 1, wherein the spatial filter has a plurality of transmissive areas arranged in a body that, in use, at least partially blocks radiation of the radiation beam.

5. The illumination system of claim 4, wherein a plurality of the transmissive areas of the spatial filter are disposed in juxtaposed registry with a corresponding, selected plurality of first raster elements

6. The illumination system of claim 5, wherein the selected plurality of first raster elements selection is arranged to provide a desired spatial intensity distribution in the pupil.

7. The illumination system of claim 6, wherein the desired spatial intensity distribution corresponds to an illumination mode comprising dipole illumination, quadrupole illumination or annular illumination.

8. The illumination system of claim 1, wherein the spatial filter is part of a set of spatial filters which all are part of a filter exchange device.

9. A lithographic method comprising:
imparting a beam of radiation exiting from an illumination system with a pattern in its cross-section using a patterning device;
projecting the pattern onto a substrate;
the illumination system including
a first optical element comprising first raster elements that partition said radiation beam into a plurality of radiation channels;
a second optical element arranged for receiving said plurality of radiation channels, and comprising second raster elements;
an object plane arranged to receive said radiation channels via said second optical element and a pupil,
wherein each raster element of said first raster elements is associated with a respective raster element of said second raster elements, and a spatial distribution of the first raster elements is incongruent to a spatial distribution of the of the respective associated second raster elements, and
wherein the method further includes spatially filtering the radiation beam to create a selected intensity distribution in the pupil.

10. The lithographic method of claim 9, wherein the spatially filtering occurs between a source, the source being arranged to provide the radiation beam to the illumination system, and the first optical element

11. The lithographic method of claim 9, wherein the spatially filtering comprises traversal of a spatial filter both by radiation impinging on the first optical element, and by radiation reflected off the first optical element.

12. The lithographic method of claim 9, wherein the spatial filtering comprises using a spatial filter having a plurality of transmissive areas arranged in a body that at least partially blocks radiation of the radiation beam, and arranging the plurality of the transmissive areas of the spatial filter in juxtaposed registry with a corresponding, selected plurality of first raster elements.

13. The lithographic method of claim 12, including arranging a selection of first raster elements constituting the selected plurality of first raster elements to provide a desired spatial intensity distribution in the pupil.

14. The lithographic method of claim 13, wherein the desired spatial intensity distribution corresponds to an illumination mode comprising dipole illumination, or quadrupole illumination, or annular illumination.

15. The lithographic method of claim 9, wherein the spatial filtering comprises using a spatial filter to create the selected spatial intensity distribution and further comprising exchanging the spatial filter for another spatial filter to create another selected spatial intensity distribution.

16. An illumination system comprising:
a first optical element to receive a radiation beam, the first optical element comprising first raster elements that partition the radiation beam into a plurality of radiation channels;
a second optical element to receive the plurality of radiation channels, the second optical element comprising second raster elements; and
a spatial filter disposed or arranged to be disposed in a path traversed by the radiation beam to create an illumination mode,
wherein, for each of the radiation channels, a raster element of the first raster elements is associated with a respective raster element of the second raster elements to provide a continuous beam path from the first optical element to an object plane arranged to receive the radiation channels via the second optical element and a pupil, the association being such that a spatial distribution of the first raster elements is not congruent to a spatial distribution of the respective associated second raster elements.

17. The illumination system of claim 16, wherein the spatial filter has a plurality of transmissive areas arranged in a body that at least partially blocks radiation of the radiation beam.

18. A lithographic method comprising:
conditioning a beam of radiation using an illumination system including a first optical element comprising first raster elements that partition the radiation beam into a plurality of radiation channels and a second optical element that receives the plurality of radiation channels, the second optical element comprising second raster elements, wherein each raster element of the first raster elements is associated with a respective raster element of the second raster elements, a spatial distribution of the first raster elements is not congruent to a spatial distribution of the respective associated second raster elements;
spatially filtering the beam of radiation to create a selected spatial intensity distribution in an exit pupil of the illumination system;
imparting the beam of radiation exiting from the illumination system with a pattern in its cross-section using a patterning device; and
projecting the pattern onto a substrate.

19. The lithographic method of claim 18, wherein the filtering comprises using a spatial filter having a plurality of transmissive areas arranged in a body that at least partially blocks radiation of the radiation beam, and a plurality of the transmissive areas of the spatial filter are in juxtaposed registry with a corresponding, selected plurality of first raster elements.
